(19) United States
(12) Patent Application Publication
(10) Pub. No.: US 2013/0246085 A1
(43) Pub. Date: Sep. 19, 2013

(54) METHOD AND APPARATUS FOR PROCESSING ELECTRONIC HEALTH RECORDS AND OTHER HEALTH DATA

(71) Applicant: ALTA VITAS, INC., Los Altos, CA (US)

(72) Inventors: Fred SEDDIQUI, Los Altos, CA (US); Jacques VAN DAM, Los Angeles, CA (US)

(73) Assignee: ALTA VITAS, INC., Los Altos, CA (US)

(21) Appl. No.: 13/782,568

(22) Filed: Mar. 1, 2013

Related U.S. Application Data
(60) Provisional application No. 61/611,659, filed on Mar. 16, 2012.

(51) Int. Cl. G06F 19/00

(52) U.S. Cl. CPC G06F 19/345
USPC 705/2

(57) ABSTRACT

According to an embodiment, a health data system receives one or more personal health records from an application. The health data system analyzes the data contained within the one or more personal health records, and receives electronic health records other health data, such as genetic data, where the electronic health records and other health data are stored on remote data sources. The health data system then selects the appropriate electronic health records and other appropriate health data based on the data contained within the one or more personal health records. The health data system can then correlate the data from the one or more personal health records with the data contained within the appropriate electronic health records and the other health data. The health data system then encapsulates the correlated data as diagnostic data, and provides the diagnostic data to one or more diagnostic clients.

### CROSS REFERENCE TO RELATED APPLICATIONS

This application claims priority under 35 U.S.C. §119(e) of U.S. Provisional Patent Application Ser. No. 61/611,659, filed on Mar. 16, 2012. The subject matter of the earlier filed application is hereby incorporated by reference.

### BACKGROUND

1. Field

Some embodiments of the invention relate generally to computer systems and particularly to healthcare computer systems. Certain embodiments also generally relate to processing of electronic health records and other health data.

2. Description of the Related Art

An electronic health record (EHR) is a systematic collection of electronic health data about individual patients or populations. It is a record in a digital format that is capable of being shared across different health settings. In some cases this sharing can occur by way of network-connected enterprise-wide computer systems. EHRs can include a range of data, including demographic characteristics, medical history, medication and allergies, immunization status, laboratory test results, radiology images, vital signs, personal statistics such as age and weight, and in some cases, billing data. One type of an electronic health record is a personal health record (PHR), which is an electronic health record that an individual patient controls.

EHRs can be stored in a variety of storage mechanisms, such as databases, and file systems. EHRs can be accessed using various types of healthcare computer systems, and the electronic health data contained within the EHRs can be accessed and displayed to one or more users.

### SUMMARY

According to an embodiment of the invention, a method includes receiving a first data input including one or more personal health records, a second data input including one or more electronic health records, and a third data input including other health data. The method further includes correlating the first data input, the second data input, and the third data input. The method further includes creating a data set including one or more attributes of an individual and one or more baseline attributes based on the first data input, the second data input, and the third data input. The method further includes generating diagnostic data, where the diagnostic data includes the first data input, the second data input, and the third data input. The method further includes sending the diagnostic data to a diagnostic client device.

According to another embodiment, an apparatus includes a processor and a memory including computer code. The memory and the computer program code are configured to, with the processor, cause the apparatus to receive a first data input including one or more personal health records, a second data input including one or more electronic health records, and a third data input including other health data. The memory and the computer program code are further configured to, with the processor, cause the apparatus to correlate the first data input, the second data input, and the third data input. The memory and the computer program code are further configured to, with the processor, cause the apparatus to create a data set including one or more attributes of an individual and one or more baseline attributes based on the first data input, the second data input, and the third data input. The memory and the computer program code are further configured to, with the processor, cause the apparatus to generate diagnostic data, where the diagnostic data includes the first data input, the second data input, and the third data input. The memory and the computer program code are further configured to, with the processor, cause the apparatus to send the diagnostic data to a diagnostic client device.

According to another embodiment, an apparatus includes means for receiving a first data input including one or more personal health records, a second data input including one or more electronic health records, and a third data input including other health data. The apparatus further includes means for correlating the first data input, the second data input, and the third data input. The apparatus further includes means for creating a data set including one or more attributes of an individual and one or more baseline attributes based on the first data input, the second data input, and the third data input. The apparatus further includes means for generating diagnostic data, where the diagnostic data includes the first data input, the second data input, and the third data input. The apparatus further includes means for sending the diagnostic data to a diagnostic client device.

According to another embodiment, a non-transitory computer-readable medium, including a computer program embodied therein, is configured to control a processor to implement a method. The method includes receiving a first data input including one or more personal health records, a second data input including one or more electronic health records, and a third data input including other health data. The method further includes correlating the first data input, the second data input, and the third data input. The method further includes creating a data set including one or more attributes of an individual and one or more baseline attributes based on the first data input, the second data input, and the third data input. The method further includes generating diagnostic data, where the diagnostic data includes the first data input, the second data input, and the third data input. The method further includes sending the diagnostic data to a diagnostic client device.

### BRIEF DESCRIPTION OF THE DRAWINGS

Further embodiments, details, advantages, and modifications of the present invention will become apparent from the following detailed description of the preferred embodiments, which is to be taken in conjunction with the accompanying drawings, wherein:

FIG. 1 illustrates a block diagram of an apparatus, according to an embodiment of the invention.

FIG. 2 illustrates a diagram of a system, according to an embodiment of the invention.

FIG. 3 illustrates a method, according to an embodiment of the invention.

### DETAILED DESCRIPTION

It will be readily understood that the components of the present invention, as generally described and illustrated in the figures herein, may be arranged and designed in a wide variety of different configurations. Thus, the following detailed description of the embodiments of a method, apparatus, system, and computer-readable medium, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

A “computer,” as understood by one of ordinary skill in the art, is any programmable machine that receives input, automatically stores and manipulates data, and provides output. A “computer program” is any sequence of instructions written to perform a specific task on a computer, and has an executable form that a computer (typically through the use of a processor) can use to execute the instructions. A “computer module,” “software module,” or “module” is any computer program, or a portion thereof, that encapsulates related functions. A “computer application,” “software application,” or “application” is any collection of computer programs and/or modules. A “computer network” or “network” is any collection of computers interconnected by communication channels that facilitate communication among the computers.

In addition, a “service” or “web service,” as understood by one of ordinary skill in the art, is a module or application designed to support interoperable computer-to-computer interaction over a network. A service can have an interface described in a computer-processable format. A computer can interact with a service by sending messages over a network protocol. Examples of services are Big Web services and RESTful services. Big Web services are services that follow a Simple Object Access Protocol (SOAP) standard and use Extensible Markup Language (XML) messages. RESTful services are services that utilize a Representational State Transfer (REST) style of software architecture, where clients are separate from servers by a uniform interface.

Furthermore, a “server” is an example of a computer that includes a computer program whose instructions serve requests of other computer programs, such as performing computation tasks on behalf of other computer programs. The term “server” can also refer to the computer program that is executed on the computer, in addition to the computer itself. A “client” is an example of a computer that includes a computer program whose instructions access one or more services made available by a server. The term “client” can also refer to the computer program that is executed on the computer, in addition to the computer itself.

According to an embodiment, a health data system can receive one or more PHRs from an application, where a PHR is a type of EHR. The health data system can analyze the data contained within the one or more PHRs, and can gather EHRs and other health data, such as genetic data, where the EHRs and other health data can be stored on remote data sources. The health data system can then select the appropriate EHRs and other appropriate health data based on the data contained within the one or more PHRs. The health data system can then correlate the data from the one or more PHRs with the data contained within the appropriate EHRs and the other health data. The health data system can then encapsulate the correlated data as diagnostic data, and provide the diagnostic data to one or more diagnostic clients.

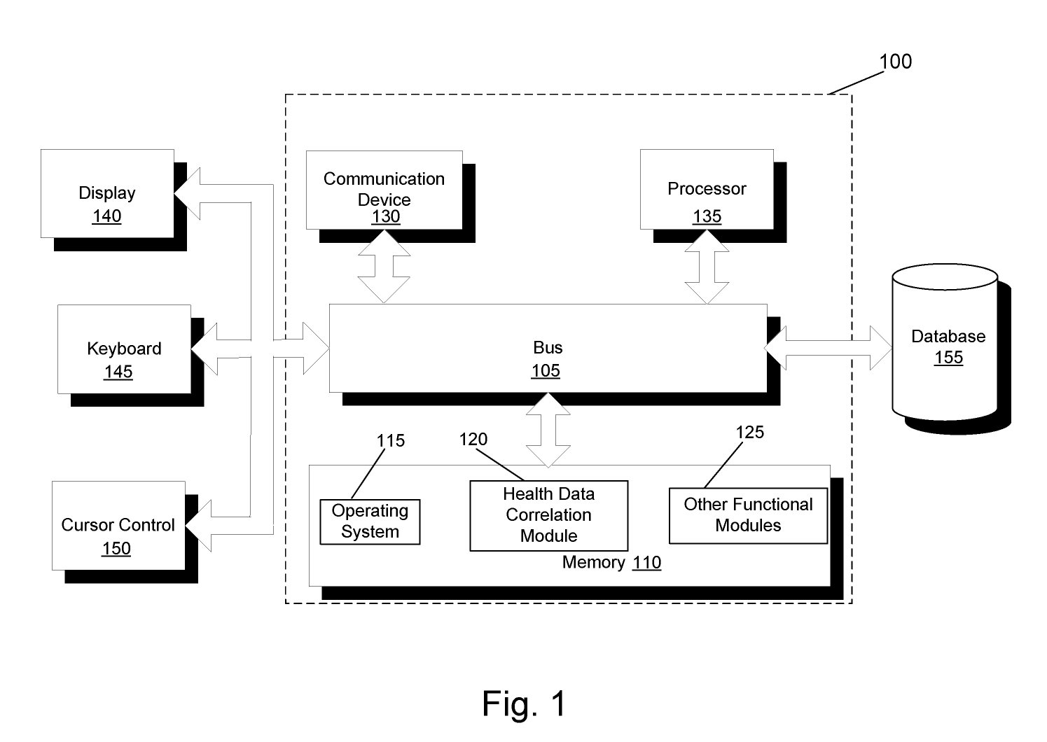

FIG. 1 illustrates a block diagram of an apparatus 100, according to an embodiment of the invention. Apparatus 100 includes a bus 105 or other communications mechanism for communicating information between components of apparatus 100. Apparatus 100 also includes a processor 135, operatively coupled to bus 105, for processing information and executing instructions or operations. Processor 135 may be any type of general or specific purpose processor. Apparatus 100 further includes a memory 110 for storing information and instructions to be executed by processor 135. Memory 110 can be comprised of any combination of random access memory (RAM), read only memory (ROM), static storage such as a magnetic or optical disk, or any other type of machine or computer-readable medium. Apparatus 100 further includes a communication device 130, such as a network interface card or other communications interface, to provide access to a network. As a result, a user may interface with apparatus 100 directly, or remotely through a network or any other method. In addition, apparatus 100 may interface with any resources through a network using communication device 130.

A computer-readable medium may be any available medium that can be accessed by processor 135. A computer-readable medium may include both a volatile and nonvolatile medium, a removable and non-removable medium, and a storage medium. A storage medium may include RAM, flash memory, ROM, erasable programmable read-only memory (EPROM), electrically erasable programmable read-only memory (EEPROM), registers, hard disk, a removable disk, a compact disc read-only memory (CD-ROM), or any other form of storage medium known in the art.

Processor 135 can also be operatively coupled via bus 105 to a display 140, such as a Liquid Crystal Display (LCD). Display 140 can display information to the user. A keyboard 145 and a cursor control device 150, such as a computer mouse, can also be operatively coupled to bus 105 to enable the user to interface with apparatus 100.

According to one embodiment, memory 110 can store software modules that may provide functionality when executed by processor 135. The modules can include an operating system 115, a health data correlation module 120, as well as other functional modules 125. Operating system 115 can provide an operating system functionality for apparatus 100. Health data correlation module 120 can provide functionality for correlating health records and other health data, as is described in more detail below. In certain embodiments, health data correlation module 120 can comprise a plurality of modules that each provide specific individual functionality for correlating health records and other health data. Apparatus 100 can also be part of a larger system. Thus, apparatus 100 can include one or more additional functional modules 125 to include the additional functionality.

Processor 135 can also be operatively coupled via bus 105 to a database 155. Database 155 can store data in an integrated collection of logically-related records or files. Database 155 can be an operational database, an analytical database, a data warehouse, a distributed database, an end-user database, an external database, a navigational database, an in-memory database, a document-oriented database, a real-time database, a relational database, an object-oriented database, or any other database known in the art.

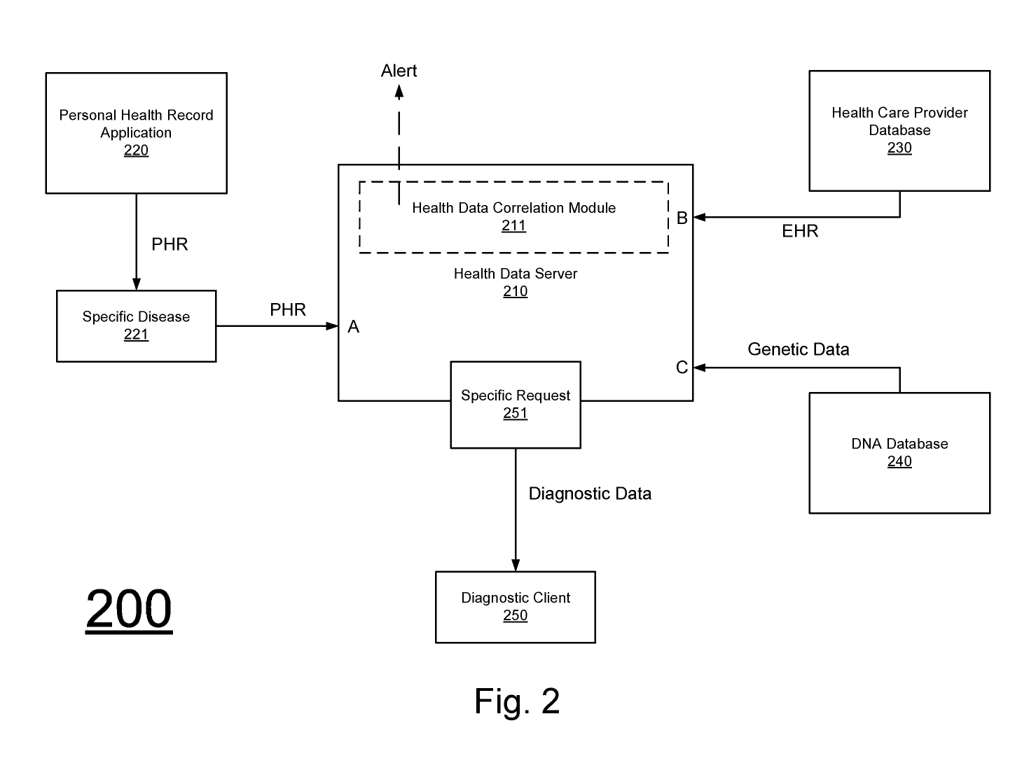

FIG. 2 illustrates a diagram of a system 200, according to an embodiment of the invention. System 200 can include health data server 210. In certain embodiments, health data server 210 is identical to apparatus 100 illustrated in FIG. 1. Health data server 210 can include one or more software applications that can be executed on health data server 210. One of these software applications can be a software application that can provide one or more algorithms for correlating health records and other health data. In certain embodiments, the software application can include health data correlation module 211, as illustrated in FIG. 2. In the illustrated embodiment, health data correlation module 211 is a module that can be stored on a memory of health data server 210 (not shown), and executed by a processor of health data server 210 (also not shown). In certain embodiments, health data correlation module 211 is identical to health data correlation module 120 of FIG. 1. Also, in certain embodiments, the software application that include health data correlation module 211 can be a web-based application.

According to the embodiment, health data correlation module 211 can initiate one or more services that can be executed on health data server 210. A service that is initiated by health data correlation module 211 can receive data over a communication protocol, and send data over the communication protocol. For example, the service can receive a Hypertext Transfer Protocol (“HTTP”) request, over an HTTP protocol, and can send an HTTP response over the HTTP protocol.

System 200 can also include a personal health record application 220. Personal health record application 220 is a software application that can generate and store one or more PHRs. As previously described, a PHR is a type of EHR. More specifically, a PHR is an EHR that can be controlled by a specific individual. The PHR can be created by personal health record application 220 based on data that is input by a user.

For example, a user can input data within personal health record application 220 associated with an individual's daily events (such as meals eaten, number of hours of sleep obtained, number of wet diapers in the case of an infant, experienced symptoms, etc.). As another example, a user can input data associated with one or more growth measurements (such as height, weight, and head circumference) within personal health record application 220. As yet another example, a user can input data associated with an individual's medications (such as dosage and frequency prescribed as well as dosage and frequency consumed by the individual). As yet another example, a user can input data associated with one or more health milestones experienced by the individual. As yet another example, a user can input one or more images associated with the data previously described, such as images of symptoms or milestones. According to certain embodiments, personal health record application 220 can receive this input data associated with an individual, and generate one or more PHRs associated with the individual.

Personal health record application 220 can be executed and stored on any type of device. In certain embodiments, personal health record application 220 can be stored on a computer, such as a desktop computer, a laptop computer, or a tablet computer. However, in alternate embodiments, a client can be another type of device, such as a personal computer, a user terminal, a portable digital assistant, a smartphone, or any type of computer or device that is known to one of ordinary skill in the relevant art.

In certain embodiments, if an individual is suffering from one or more specific disease, a user can input data that is associated with the one or more diseases (such as the name of each respective disease, or one or more symptoms associated with each respective disease). For example, if an individual is obese, data (such as individual's weight or eating habits) can be input into personal health record application 220 (illustrated in FIG. 2 as specific disease 221), where the data is associated with the specific disease of obesity. This input data can be associated with the one or more PHRs created by personal health record application 220.

Personal health record application 220 can then communicate the one or more PHRs to health data server 210. In the illustrated embodiment of FIG. 2, this is illustrated as input “A” of health data server 210. According to certain embodiments, personal health record application 220 can communicate the one or more PHRs over a communication protocol, such as an HTTP protocol.

System 200 can also include a health care provider server 230. Health care provider server 230 is a server of a health care provider that generates and stores one or more EHRs. As previously described, an EHR is a systematic collection of electronic health data about individual patients or populations. Examples of health care providers include hospitals, physician offices, health clinics, or integrated delivery networks. The one or more EHRs can be stored within a data store (not shown) that is operatively connected to health care provider server 230. Such a data store can be an operational database, an analytical database, a data warehouse, a distributed database, an end-user database, an external database, a navigational database, an in-memory database, a document-oriented database, a real-time database, a relational database, an object-oriented database, or any other database known in the art. Health care provider server 230 can then communicate the one or more EHRs to health data server 210. In the illustrated embodiment of FIG. 2, this is illustrated as input “B” of health data server 210. According to certain embodiments, health care provider server 230 can communicate the one or more EHRs over a communication protocol, such as an HTTP protocol.

System 200 can also include a deoxyribonucleic acid (DNA) server 240. DNA server 240 is a server of an entity that generates and stores genetic data. Examples of entities that generate and store genetic data include government entities, such as the FBI, that store genetic data associated with criminals, and government health care providers, such as the Danish Newborn Screening Biobank, that retain genetic data associated with newborn babies for the purpose of genetic disease testing and prevention. The genetic data can be stored within a data store (not shown) that is operatively connected to DNA server 240. Such a data store can be an operational database, an analytical database, a data warehouse, a distributed database, an end-user database, an external database, a navigational database, an in-memory database, a document-oriented database, a real-time database, a relational database, an object-oriented database, or any other database known in the art. DNA server 240 can then communicate the genetic data to health data server 210. In the illustrated embodiment of FIG. 2, this is illustrated as input “C” of health data server 210. According to certain embodiments, DNA server 240 can communicate the genetic data over a communication protocol, such as an HTTP protocol.

System 200 can also include diagnostic client 250. Diagnostic client 250 is an application that can receive diagnostic data, where diagnostic data can include one or more PHRs, one or more EHRs, other health data, or a combination therein. Diagnostic client 250 can also display the diagnostic data within a user interface. Diagnostic client 250 can be executed and stored on any type of device. In certain embodiments, diagnostic client 250 can be stored on a computer, such as a desktop computer, a laptop computer, or a tablet computer. However, in alternate embodiments, a client can be another type of device, such as a personal computer, a user terminal, a portable digital assistant, a smartphone, or any type of computer or device that is known to one of ordinary skill in the relevant art.

According to the illustrated embodiment, health data correlation module 211 of health data server 210 includes one or more algorithms for receiving data represented by inputs A, B, and C, correlating data represented by inputs A, B, and C, and generating diagnostic data that encapsulates the correlated data. More specifically, in certain embodiments, health data correlation module 211 of health data server 210 includes an algorithm that receives: (a) one or more PHRs (i.e., input A) that are associated with an individual; (b) one or more EHRs (i.e., input B) that are associated with the individual, or associated with one or more demographic characteristics of the individual; and (c) genetic data (i.e., input C) that is associated with the individual, or associated with one or more demographic characteristics of the individual. The algorithm subsequently correlates inputs A, B, and C. This correlation can include linking data together from each input, where the data is either associated with the individual or associated with one or more demographic characteristics of the individual. The algorithm then generates a data set, such as a plot, that includes one or more health-related attributes of the individual and one or more health-related attributes of a “normal” individual, where a “normal” individual is a baseline determined based on the one or more demographic characteristics of the individual, and the health-related attributes of the “normal” individual serve as baseline attributes. This data set is based on the correlated inputs A, B, and C. The algorithm then causes health data server 210 to transmit the data set to diagnostic client 250.

According to the embodiment, the algorithm further analyzes the data set, and determines if the one or more health-related attributes of the individual deviates from the one or more health-related attributes of a “normal” individual. The algorithm further determines if the deviation is greater than a pre-defined threshold. In the event that the deviation is greater than a pre-defined threshold, the algorithm generates an alert indication. The algorithm further causes health data server 210 to transmit the alert indication to diagnostic client 250. Diagnostic client 250 then displays the alert indication to a user within a user interface. For example, diagnostic client 250 can display a dialog box that includes the alert indication, and can optionally include the data set so as to illustrate the deviation to a user.

In addition, in certain embodiments, health data correlation module 211 of health data server 210 includes an algorithm that receives a request for diagnostic data (identified in FIG. 2 as specific request 251), where the diagnostic data includes correlated inputs A, B, and C. The algorithm encapsulates correlated inputs A, B, and C into diagnostic data. The algorithm then causes health data server 210 to transmit the diagnostic data to diagnostic client 250. Diagnostic client 250 then displays the diagnostic data to a user within a user interface. For example, diagnostic client 250 can displays a screen that includes the diagnostic data, where the diagnostic data includes correlated inputs A, B, and C.

System 200, as illustrated in FIG. 2, is merely an example system according to an embodiment of the invention. One of ordinary skill in the art would readily appreciate that a system can have other configurations according to alternate embodiments, and still be a within a scope of the invention. For example, a system can include any number of personal health record applications, health care provider servers, DNA servers, and diagnostic clients.

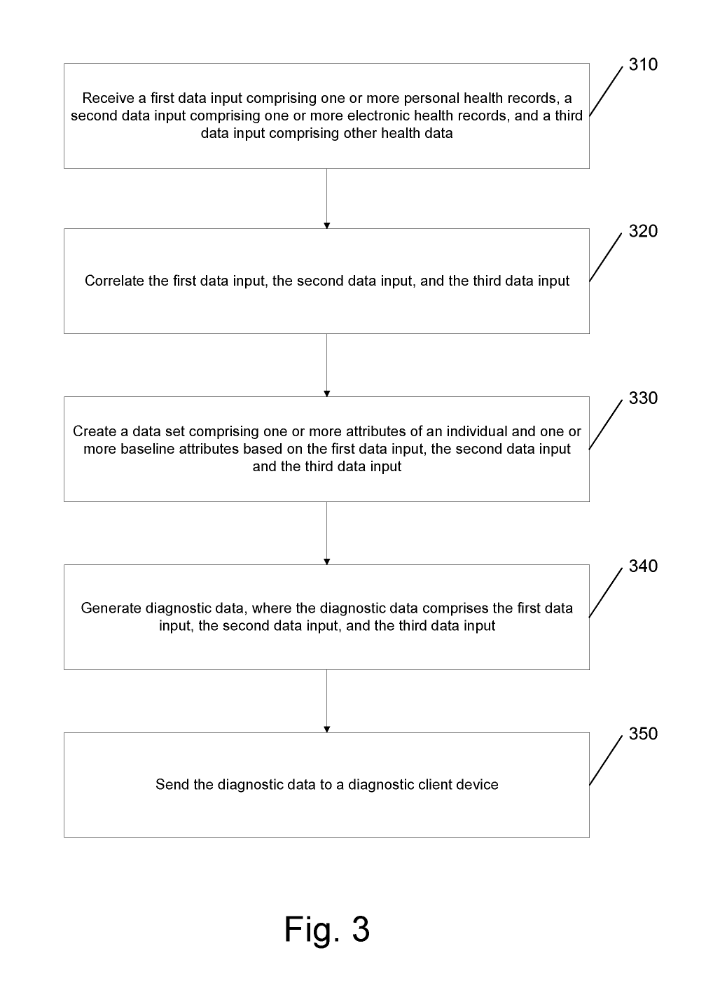

FIG. 3 illustrates a method, according to an embodiment of the invention. At step 310, a first data input, a second data input, and a third data input is received. The first data input includes one or more personal health records. The second data input includes one or more electronic health records. The third data input includes other health data, such as genetic data. At step 320, the first data input, the second data input, and the third data input are correlated. At step 330, a data set is created based on the first data input, the second data input, and the third data input, where the data set includes one or more attributes of an individual, and one or more baseline attributes. At step 340, diagnostic data is generated, where the diagnostic data includes the first data input, the second data input, and the third data input. At step 350, the diagnostic data is sent to a diagnostic client device. In certain embodiments, the method is implemented at a server. Also, in certain embodiments, the method includes additional steps described in relation to FIG. 2.

The steps of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in RAM, flash memory, ROM, EPROM, EEPROM, registers, hard disk, a removable disk, a CD-ROM, or any other form of storage medium known in the art. An exemplary storage medium may be coupled to the processor such that the processor can read information from, and write information to, the storage medium. In the alternative, the storage medium may be integral to the processor. The processor and the storage medium may reside in an application specific integrated circuit (ASIC). In the alternative, the processor and the storage medium may reside as discrete components.

Thus, according to certain embodiments, a health care provider, such as a physician, can request data related to a patient, and receive diagnostic data that correlates health data regarding the patient from multiple sources. The diagnostic data can be sent to any type of device, such as a mobile device. Thus, the physician can receive detailed data regarding one or more patients no matter where the physician is located.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method, comprising:
receiving a first data input comprising one or more personal health records, a second data input comprising one or more electronic health records, and a third data input comprising other health data;
correlating the first data input, the second data input, and the third data input;
creating a data set comprising one or more attributes of an individual and one or more baseline attributes based on the first data input, the second data input, and the third data input;
generating diagnostic data, wherein the diagnostic data comprises the first data input, the second data input, and the third data input; and
sending the diagnostic data to a diagnostic client device.

2. The method of claim 1, wherein the diagnostic client device displays the diagnostic data within a user interface.

3. The method of claim 1, further comprising:
determining if the one or more attributes of the individual deviate from the one or more baseline attributes;
determining if a deviation is greater than a pre-defined threshold when the one or more attributes of the individual deviate from the one or more baseline attributes; and
transmitting an alert indication to the diagnostic client device when the deviation is greater than the pre-defined threshold.

4. The method of claim 3, wherein the diagnostic client device displays the alert indication within a user interface.

5. The method of claim 1, wherein the other health data comprises genetic data.

6. The method of claim 1, wherein the one or more personal health records are created based on data that is input by a user.

7. The method of claim 6, wherein the data that is input by the user comprises at least one of: data associated with one or more daily events of an individual, data associated with one or more growth measurements of an individual, data associated with one or more medications of an individual, data associated with one or more health milestones of an individual, data associated with one or more diseases, or one or more images.

8. The method of claim 1, wherein the receiving, correlating, creating, generating, and sending are each performed by a health data server.

9. The method of claim 1, wherein the second data input and the third data input are each stored on a remote data source.

10. An apparatus, comprising:
a processor;
a memory comprising computer code;
the memory and the computer code being configured, with the processor, to cause the apparatus, at least, to:
receive a first data input comprising one or more personal health records, a second data input comprising one or more electronic health records, and a third data input comprising other health data;
correlate the first data input, the second data input, and the third data input;
create a data set comprising one or more attributes of an individual and one or more baseline attributes based on the first data input, the second data input, and the third data input;
generate diagnostic data, wherein the diagnostic data comprises the first data input, the second data input, and the third data input; and
send the diagnostic data to a diagnostic client device.

11. The apparatus of claim 10, wherein the diagnostic client device displays the diagnostic data within a user interface.

12. The apparatus of claim 10, the memory and the computer code being further configured, with the processor, to cause the apparatus, at least, to:
determine if the one or more attributes of the individual deviate from the one or more baseline attributes;
determine if a deviation is greater than a pre-defined threshold when the one or more attributes of the individual deviate from the one or more baseline attributes; and
transmit an alert indication to the diagnostic client device when the deviation is greater than the pre-defined threshold.

13. The apparatus of claim 12, wherein the diagnostic client device displays the alert indication within a user interface.

14. The apparatus of claim 10, wherein the other health data comprises genetic data.

15. The apparatus of claim 10, wherein the one or more personal health records are created based on data that is input by a user.

16. The apparatus of claim 15, wherein the data that is input by the user comprises at least one of: data associated with one or more daily events of an individual, data associated with one or more growth measurements of an individual, data associated with one or more medications of an individual, data associated with one or more health milestones of an individual, data associated with one or more diseases, or one or more images.

17. The apparatus of claim 10, wherein the apparatus comprises a health data server.

18. The apparatus of claim 10, wherein the second data input and the third data input are each stored on a remote data source.

19. An apparatus, comprising:
means for receiving a first data input comprising one or more personal health records, a second data input comprising one or more electronic health records, and a third data input comprising other health data;
means for correlating the first data input, the second data input, and the third data input;
means for creating a data set comprising one or more attributes of an individual and one or more baseline attributes based on the first data input, the second data input, and the third data input;
means for generating diagnostic data, where the diagnostic data comprises the first data input, the second data input, and the third data input; and
means for sending the diagnostic data to a diagnostic client device.

20. A computer program, embodied on a non-transitory computer-readable medium, configured to control a processor to implement a method, the method comprising:
receiving a first data input comprising one or more personal health records, a second data input comprising one or more electronic health records, and a third data input comprising other health data;
correlating the first data input, the second data input, and the third data input;
creating a data set comprising one or more attributes of an individual and one or more baseline attributes based on the first data input, the second data input, and the third data input;
generating diagnostic data, wherein the diagnostic data comprises the first data input, the second data input, and the third data input; and
sending the diagnostic data to a diagnostic client device.
